(19) United States
(12) Patent Application Publication
(10) Pub. No.: US 2025/0245478 A1
(43) Pub. Date: Jul. 31, 2025

(54) SYSTEMS AND METHODS FOR NEXT-BEST ACTION USING A MULTI-OBJECTIVE REWARD BASED SEQUENTIAL FRAMEWORK

(71) Applicant: Walmart Apollo, LLC, Bentonville, AR (US)

(72) Inventors: Shubham Yograj Thakur, San Francisco, CA (US); Ayush Agarwal, Sunnyvale, CA (US); Rahul Radhakrishnan Iyer, Sunnyvale, CA (US); Hyun Duk Cho, San Francisco, CA (US); Sushant Kumar, San Jose, CA (US); Kannan Achan, Saratoga, CA (US)

(21) Appl. No.: 18/429,182

(22) Filed: Jan. 31, 2024

(51) Int. Cl. G06N 3/0442; G06N 3/045; G06N 3/092

(52) U.S. Cl. CPC G06N 3/0442; G06N 3/045; G06N 3/092

(57) ABSTRACT

In various embodiments, systems and methods for generating interfaces including interface elements representative of next-best actions are disclosed. A request for an interface including a set of features representative of a user associated with the request is received and a user state representation including an implicit user state representation and an explicit user state representation is generated based on the set of features and session data for at least one session associated with the user. An action reward value for each of a plurality of candidate actions is generated based on the user state representation and an interface including at least one interface element representative of a candidate action having a highest action reward value is generated.

### TECHNICAL FIELD

This application relates generally to next-action prediction, and more particularly, to next-action prediction using a generalized framework.

### BACKGROUND

User interactions with computing devices include interactions through interfaces that present current or future actions that may be selected and executed by a user. Some current systems attempt to predict actions that will be taken by a user to reduce computational load, present relevant actions to a user, or increase interaction with an interface. Although these current systems can make predictions within narrow contexts or narrow targets, such systems are not able to generalize action prediction to user interactions across an interface.

### SUMMARY

In various embodiments, a system including a non-transitory memory and a processor communicatively coupled to the non-transitory memory is disclosed. The processor is configured to read a set of instructions to receive a request for an interface including a set of features representative of a user associated with the request, generate a user state representation including an implicit user state representation and an explicit user state representation based on the set of features and session data for at least one session associated with the user, generate an action reward value for each of a plurality of candidate actions based on the user state representation, and generate an interface including at least one interface element representative of a candidate action having a highest action reward value.

In various embodiments, a computer-implemented method is disclosed. The computer-implemented method includes steps of receiving a request for an interface including a set of features representative of a user associated with the request, generating a user state representation including an implicit user state representation and an explicit user state representation based on the set of features and a user representation including a triplet comprising historical user features, a current action, and a current response, generating an action reward value for each of a plurality of candidate actions based on the user state representation, and generating an interface including at least one interface element representative of a candidate action having a highest action reward value.

In various embodiments, a non-transitory computer readable medium having instructions stored thereon is disclosed. The instructions, when executed by at least one processor, cause at least one device to perform operations including receiving a request for an interface including a set of features representative of a user associated with the request and generating a user state representation including an implicit user state representation and an explicit user state representation based on the set of features and session data for at least one session associated with the user. The user state representation is generated by a trained personalized representation model including a first portion configured to generate the implicit user state representation and a second portion configured to generate the explicit user state representation. The first portion of the trained personalized representation model comprises a reinforced coupled recurrent network and the second portion of the trained personalized representation model comprises at least one fully-connected network. The instructions further cause the at least one device to perform operations including generating an action reward value for each of a plurality of candidate actions based on the user state representation and generating an interface including at least one interface element representative of a candidate action having a highest action reward value.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide next-action prediction and interface generation, in accordance with some embodiments;

FIG. 2 illustrates a computer system configured to implement one or more processes, in accordance with some embodiments;

FIG. 3 is a flowchart illustrating a next-action prediction and interface generation method, in accordance with some embodiments;

FIG. 4 is a process flow illustrating various steps of the next-action prediction and interface generation method of FIG. 3, in accordance with some embodiments;

FIG. 5 illustrates a trained personalized representation model, in accordance with some embodiments;

FIG. 6 illustrates a coupled recurrent unit of a coupled recurrent network, in accordance with some embodiments;

FIG. 7 illustrates a residual network framework configured to measure a reward of each decision action on a user, in accordance with some embodiments;

FIG. 8 illustrates an artificial neural network, in accordance with some embodiments;

FIG. 9 illustrates a tree-based artificial neural network, in accordance with some embodiments;

FIG. 10 illustrates a deep neural network (DNN), in accordance with some embodiments;

FIG. 11 is a flowchart illustrating a training method for generating a trained machine learning model, in accordance with some embodiments; and

FIG. 12 is a process flow illustrating various steps of the training method of FIG. 11, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for next-action prediction and interface generation. In various embodiments, a next-action prediction is generated based on a personalized representation and an action reward prediction. The action reward prediction is configured to account for both short-term rewards and long-term rewards. In some embodiments, a personalized representation is generated by a personalized representation module configured to apply a trained representation model configured to generate a dense representation of a user state and an action reward prediction is generated by a reward prediction module configured to receive the dense representation of a user state and an action selected from a candidate action set to generate a reward value. The reward value may be used to select one or next actions and/or one or more interface elements representative of one or more next actions for inclusion in a generated interface.

In some embodiments, systems, and methods for next-action prediction and interface generation include one or more trained personalized representation models and/or reward prediction models. The trained personalized representation models and/or reward prediction models may include one or more models, such as models including one more embedding layers, one or more reinforced coupled recurrent networks, one or more ResNet models, etc.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

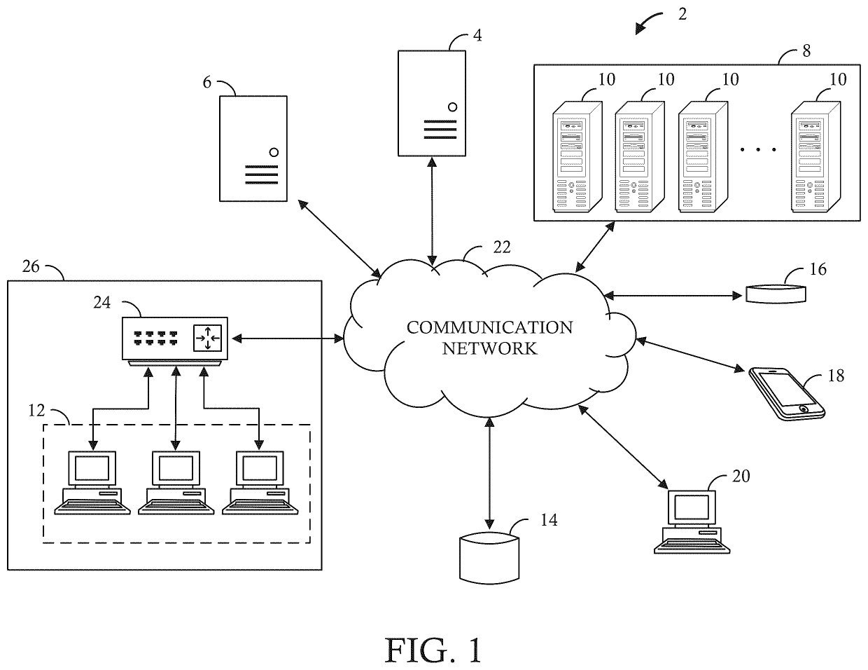

FIG. 1 illustrates a network environment 2 configured to provide next-action prediction and interface generation, in accordance with some embodiments. The network environment 2 includes a plurality of devices or systems configured to communicate over one or more network channels, illustrated as a network cloud 22. For example, in various embodiments, the network environment 2 may include, but is not limited to, a next-action prediction computing device 4, a web server 6, a cloud-based engine 8 including one or more processing devices 10, a database 14, and/or one or more user computing devices 16, 18, 20 operatively coupled over the network 22. The next-action prediction computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the next-action prediction computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the next-action prediction computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment. In some embodiments, the next-action prediction computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the next-action prediction computing device 4, for example. The workstation(s) 12 may communicate with the next-action prediction computing device 4 over the communication network 22. The workstation(s) 12 may send data to, and receive data from, the next-action prediction computing device 4. For example, the workstation(s) 12 may transmit data related to tracked operations performed at the physical location 26 to next-action prediction computing device 4.

Although FIG. 1 illustrates three user computing devices 16, 18, 20, the network environment 2 may include any number of user computing devices 16, 18, 20. Similarly, the network environment 2 may include any number of the next-action prediction computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the next-action prediction computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the first user computing device 16, the second user computing device 18, and the Nth user computing device 20 may communicate with the web server 6 over the communication network 22. For example, each of the user computing devices 16, 18, 20 may be operable to view, access, and interact with a website, such as an e-commerce website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in the search results. The website may capture these activities as user session data, and transmit the user session data to the next-action prediction computing device 4 over the communication network 22. The website may also allow the user to interact with one or more of interface elements to perform specific operations (e.g., actions), such as selecting one or more items for further processing. In some embodiments, the web server 6 transmits user interaction data identifying interactions between the user and the website to the next-action prediction computing device 4.

In some embodiments, the next-action prediction computing device 4 may execute one or more models, processes, or algorithms, such as a machine learning model, deep learning model, statistical model, etc., to generate a personalized representation, determine a reward value, etc. The next-action prediction computing device 4 may transmit one or more predicted next-action identifiers to the web server 6 over the communication network 22, and the web server 6 may display interface elements associated with the next-action identifiers on the website to the user and/or modify the website to allow execution of one or more predicted next-actions. For example, the web server 6 may display interface elements associated with next-action predictions to the user on a homepage, a catalog webpage, an item webpage, a window or interface of a chatbot, a search results webpage, or a post-transaction webpage of the website (e.g., as the user browses those respective webpages).

In some embodiments, the web server 6 transmits a next-action prediction request to the next-action prediction computing device 4. The next-action prediction request may include a user identifier, session data, and/or any other suitable data. The next-action prediction computing device 4 implements one or more models, such as a personalized representation model to generate a personalized representation and/or a reward prediction model to generate a predicted reward value. The next-action prediction computing device 4 identifies a set of next actions with associated predicted rewards and provides a subset of the identified next-actions to the web server 6 in response to the next-action prediction request.

The next-action prediction computing device 4 is further operable to communicate with the database 14 over the communication network 22. For example, the next-action prediction computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the next-action prediction computing device 4, in some embodiments, the database 14 may be a local storage device, such as a hard drive, a non-volatile memory, or a USB stick. The next-action prediction computing device 4 may store interaction data received from the web server 6 in the database 14. The next-action prediction computing device 4 may also receive from the web server 6 user session data identifying events associated with browsing sessions, and may store the user session data in the database 14.

In some embodiments, the next-action prediction computing device 4 generates training data for a plurality of models (e.g., machine learning models, deep learning models, statistical models, algorithms, etc.) based on aggregation data, variant-level data, holiday and event data, recall data, historical user session data, search data, purchase data, catalog data, advertisement data for the users, etc. The next-action prediction computing device 4 and/or one or more of the processing devices 10 may train one or more models based on corresponding training data. The next-action prediction computing device 4 may store the models in a database, such as in the database 14 (e.g., a cloud storage database).

The models, when executed by the next-action prediction computing device 4, allow the next-action prediction computing device 4 to generate a dense representation of a user state and/or generate a predicted reward value. For example, the next-action prediction computing device 4 may obtain one or more models from the database 14. The next-action prediction computing device 4 may then receive, in real-time from the web server 6, a next-action prediction request. In response to receiving the next-action prediction request, the next-action prediction computing device 4 may execute one or more models to generate one or more next-action predictions and/or corresponding reward values.

In some embodiments, the next-action prediction computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units.

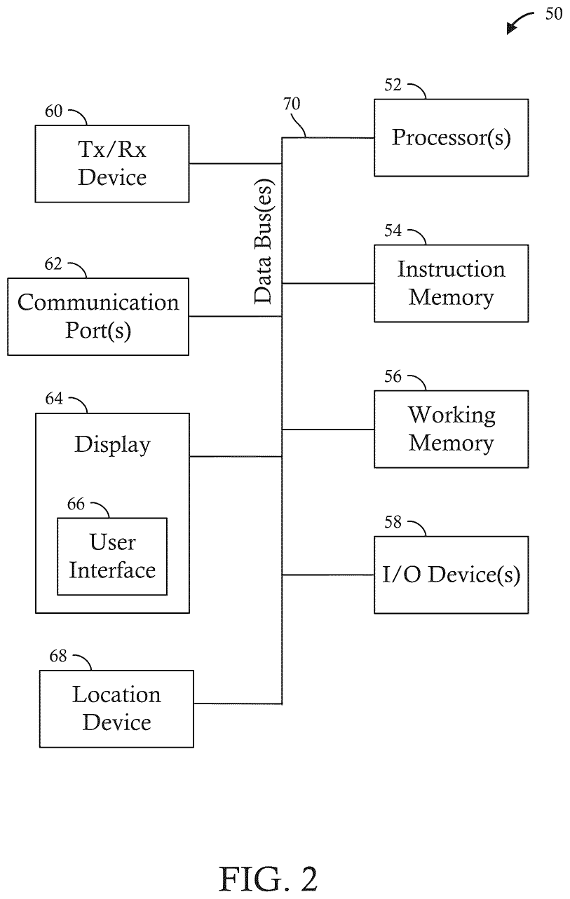

FIG. 2 illustrates a block diagram of a computing device 50, in accordance with some embodiments. In some embodiments, each of the next-action prediction computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™ Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for next-action prediction and interface generation, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with interface elements representative of predicted next-actions. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

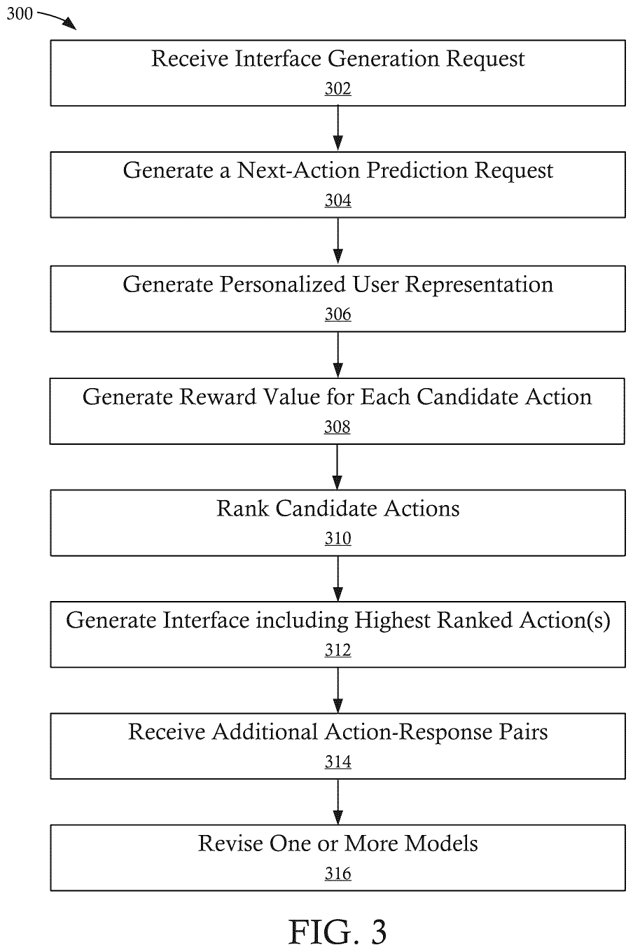

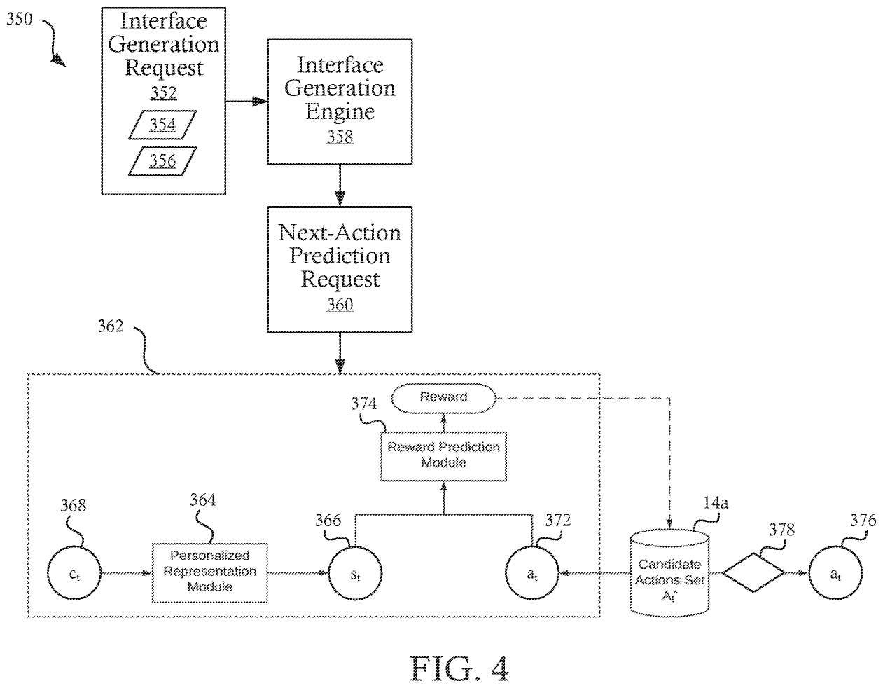

FIG. 3 is a flowchart illustrating a next-action prediction and interface generation method 300, in accordance with some embodiments. FIG. 4 is a process flow 350 illustrating various steps of the next-action prediction and interface generation method 300, in accordance with some embodiments. The next-action prediction and interface generation method 300 may be implemented by any suitable system or systems, such as, for example, a next-action prediction computing device 4, a web server 6, one or more processing devices 10, etc.

At step 302, an interface generation request 352 is received. The interface generation request 352 may be generated by any suitable system, such as a user computing device 16, 18, 20, and received by any suitable system, such as the next-action prediction computing device 4 and/or the web server 6. The interface generation request 352 may be received by an interface generation engine 358 executed by one or more devices, such as the next-action prediction computing device 4 and/or the webs server 6. The interface generation request 352 may include a user identifier 354 corresponding to a user data structure associated with the user computing device 16, 18, 20 that generated the interface generation request 352 and/or session data 356 representative of one or more user interactions with an interface during one or more current and/or prior sessions.

At step 304, the interface generation engine 358 generates a next-action prediction request 360, which is received by a next-action prediction engine 362. The next-action prediction request 360 may be generated by any suitable system, such as a web server 6, and received by any suitable system, such as the next-action prediction computing device 4. The next-action prediction request 360 may include the user identifier 354 and/or at least a portion of the session data 356.

At step 306, a personalized user representation 366 is generated. The personalized user representation may include a dense representation of a user state of the user corresponding to the user identifier 354. In some embodiments, the personalized user representation 366 is generated by a personalized representation module 364. The personalized user representation 366 may be configured to represent and/or capture user targeting and/or gamification features of the corresponding user.

In some embodiments, the personalized representation module 364 is configured to receive an user representation input 368 representative of a user at a time t. In some embodiments, the user representation input 368 includes a triplet Cₜ: [symbol] Dₜ, Aₜ₋₁, Oₜ [symbol] where Dₜ is a set of features representing a user, Aₜ₋₁ is a sequence of past actions at time t−1, and Oₜ is a sequence of user responses to corresponding assigned actions in the set sequence of past actions Aₜ₋₁. The set of user features Dₜ may include one or more historical features, user preferences features, user provided information, user persona features, and/or any other suitable user features. The set of past action Aₜ₋₁ may be assigned to a user by an assignment process (e.g., an interaction log) during an interaction period and the set of client responses Oₜ may include responses occurring after (e.g., immediately after, within a predetermined time period, prior to another action or response, etc.) an associated past action. The user representation input 368 (e.g., Cₜ) may be representative of user circumstance, behaviors, prior decision making actions, and/or prior responses to actions to provide a comprehensive representation of user states.

In some embodiments, the personalized representation module 364 is configured to implement a trained personalized representation model. The trained personalized representation model may be configured to generate a representation, e.g., personalized user representation 366, including a comprehensive vector representation at a given time (e.g., at the time of generation of the interface generation request 352 and/or the next-action prediction request 360). In some embodiments, the personalized representation module 364 is configured to generate the personalized user representation 366 by combining two or more vector representations of a user state, such as, for example, a vector representation based on implicit features and a vector representation based on explicit features. The personalized representation model may be configured to receive the user representation input 368 (e.g., Cₜ) and generate an personalized user representation 366 (e.g., sₜ). In some embodiments, the personalized user representation 366 sₜ is a dense representation of a user state.

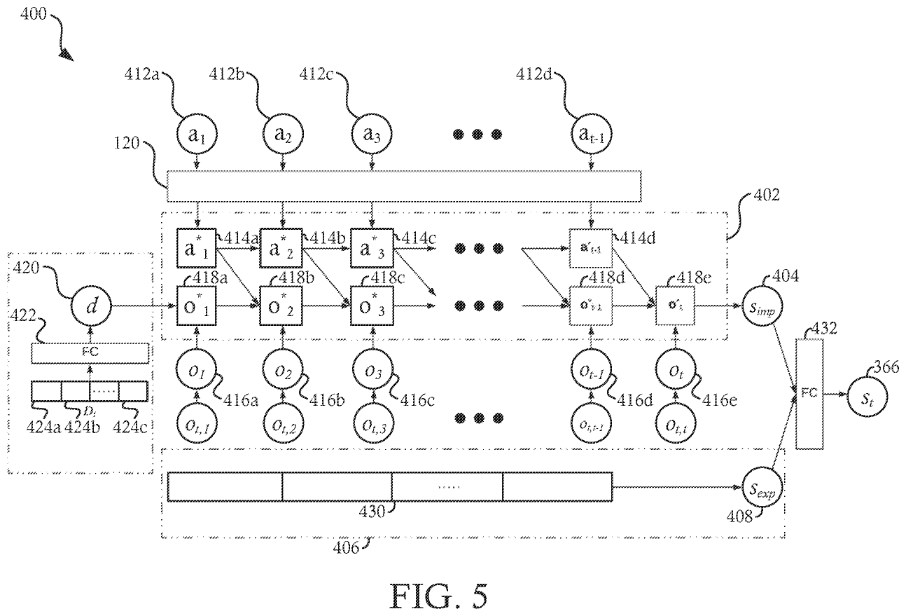

FIG. 5 illustrates a trained personalized representation model 400, in accordance with some embodiments. The trained personalized representation model 400 a learning action-state network 402 configured to generate an implicit user state representation 404 and a domain-driven network 406 configured to generate an explicit user state representation 408. The learning-action state network 402 models a plurality of learning-action state interactions to identify connections between sequential prior responses and next actions. The learning action-state network 402 is configured to receive an input representative of a user state (d) 420. The user state 420 may be an embedding representation of a user state generated by a fully-connected (FC) network 422 configured to receive a user state input Dₜ 424 including a plurality of user state features, such as, for example, a user persona 424a, a customer understanding (CU) 424b, a user intent 424c, interpurchase interval, interaction frequency, interaction count, etc.

In some embodiments, the learning action-state network 402 includes sequential framework including a plurality of action nodes 414a-414d for each action 412a-412d, where aₜ is an action that occurred at time t, and a set of response nodes 416a-416e for a set of responses 418a-418e, where oₜ is a response at time. The response oₜ occurring at time t corresponds to an action at time t− 1, e.g., aₜ₋₁. For example, for action a₁, the corresponding response occurs at time t=2, e.g., o₂. The response at time t=1 may be determined based on the user state input d 420.

An action embedding layer 410 may be configured to convert each of a sequence of actions 412a-412d into an embedding (e.g., vector) representation and/or other numerical representation of a corresponding action 412a-412d. The action embedding layer 410 may include any suitable embedding layer configured to convert individual actions 412a-412d into embeddings representations, such as a semantic embedding generation process, a feature-based embedding generation process, a numerical mapping process, etc. The generated action representations may be provided to and/or may be implemented as the corresponding action nodes 414a-414d. Similarly, in some embodiments, response nodes 416a-416e may be generated based on embedding representations and/or other numerical representations of responses 418a-418e.

As illustrated in FIG. 5, an action at time t, e.g., at, is connected to a next action, e.g., aₜ₊₁ and a next response, e.g., oₜ₊₁, e.g., a current action influences both the next action aₜ₊₁ that is provided to a user and influences a response, oₜ₊₁ to the current action at. In addition, the next response oₜ₊1 is connected to the current response oₜ, e.g., the next response oₜ₊₁ is influenced by the prior response oₜ. Although the connections between actions and/or responses are directional from a past time t to a next time t+1, it will be appreciated that the connections and/or influences may also be interpreted in a reverse direction. Further, influences from a prior action at and/or a prior response oₜ may be propagated through downstream actions and/or responses, e.g., action at may influence not only action aₜ₊₁ but additional subsequent actions such as aₜ₊₂, aₜ₊₃, etc. The connections between the action nodes 414a-414d, between the action nodes 414a-414d and the response nodes 416a-416e, and between the response nodes 416a-416e provide a multilevel sequence passing of information that enables robust generation of an implicit user state representation (simp) 404 for input user state information Dₜ.

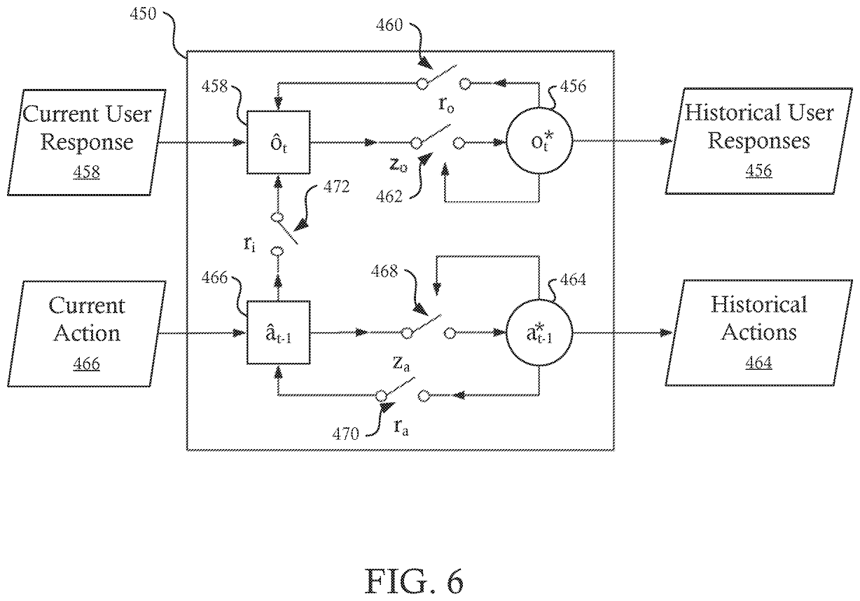

In some embodiments, the learning-action state network 402 includes a recurrent neural network (RNN), such as a coupled recurrent network (CRN), a reinforced coupled recurrent network (RCRN), etc. An RNN, e.g., a CRN and/or an RCRN, may include one or more recurrent units, such as a gated recurrent unit (GRU), a coupled recurrent unit (CRU), etc. configured to store historical information and generate an output based on historical states. FIG. 6 illustrates a CRU 450, in accordance with some embodiments. The CRU 450 is configured to receive two inputs, e.g., a historical user response input 452 and a historical decision action 454. Each of the inputs 452, 454 may include an output of a prior CRU 450 within a corresponding network, such a corresponding RCRN.

In some embodiments, the CRU 450 includes a first gate, rₒ 460 configured to control an impact of historical response information oₜ* 456 on the current response ôₜ 458 and a second gate zₒ 462 configured to control an impact of the current response ôₜ 458 on the historical response information oₜ* 456, e.g., how much to update the historical response information oₜ* 456 based on the current response ôₜ 458. Similarly, in some embodiments, the CRU 450 includes a third gate rₐ 468 configured to control an impact of historical action information aₜ₋₁* 464 on the current action âₜ₋₁ 466 and a second gate zₐ 470 configured to control an impact of the current action aₜ₋₁, 466 on the historical action information aₜ₋₁* 464, e.g., how much to update the historical action information aₜ₋₁* 464 based on the current action âₜ₋₁ 466. A fifth gate, rᵢ 472, may be configured to capture a dependence between a current action âₜ₋₁ 466 and a current response ôₜ 458.

With reference again to FIG. 5, the trained personalized representation model 400 further includes a domain-driven network 406 configured to generate an explicit user state representation (sₑₓₚ) 408 based on domain-driven features 430. The domain-driven features 430 may include any domain features, such as, for example, location features (e.g., zip code), system features (e.g., browser, system specifications, etc.), asset related information, etc. The domain-driven network 406 may include a fully-connected network configured to generate an embedding representation of each of the one or more domain-driven features 430.

In some embodiments, the implicit user state representation (sᵢₘₚ) 404 and the explicit user state representation (sₑₓₚ) 408 are combined by a FC network 432. The output of the fully-connected network 432 includes the personalized user representation (sₜ) 366. Although embodiments including a FC network 432 are illustrated, it will be appreciated that any suitable combinatorial network may be used to combine the implicit user state representation (sᵢₘₚ) 404 and the explicit user state representation (sₑₓₚ) 408.

With reference again to FIGS. 3-4, at step 308, a reward value 370 is generated for each of a plurality of candidate actions 372. Each candidate action 372 is representative of a potential action that may be taken by a user during an interaction with a user interface. A candidate action 372 may include context-specific actions (e.g., actions available for a given context or given interface page), platform-specific actions (e.g., actions available for a given platform within a network environment), network-specific actions, and/or any other suitable actions. Each candidate action 372 may be represented by a candidate action data structure stored on one or more datastores, such as a candidate action database 14a.

A reward value 370 may be representative of a value assigned for a given action and the probability of a user performing an action given the user state sₜ. A reward value 370 may be stored in conjunction with each candidate actions 372, such as part of a candidate action data structure. A reward value 370 may include a value r_{<c}_{ᵢ}_{,a}_{ᵢ}_{>} representative of an effectiveness of an action aᵢ available at time t on a next client response O_{i,t+1}, e.g., for the current user state sₜ, what is the value of each of the available next actions aᵢ. In embodiments including a single action for any given timestamp, the reward value r_{<c}_{ᵢ}_{,a}_{ᵢ}_{>} may be written as r_{<c}_{ₜ}_{,a}_{ᵢ}_{>}, where cₜ is the action available at time t. A reward value 670 may be stored in conjunction with a representation of a corresponding candidate action 372, such as, for example, being stored as part of a candidate action data structure stored in a candidate action database 14a, being stored in a referential data structure having a reference to the corresponding candidate action 372, and/or including any other suitable storage structure.

In some embodiments, the reward value 370 for each candidate action 372 is generated by a reward prediction module 374. The reward prediction module 374 may be configured to receive the personalized user representation sₜ 366 and each candidate action 372 (e.g., a candidate action data structure, an embedding representation at, etc.) and generate a reward value 370 for each combination of the personalized user representation sₜ 366 and candidate action 372. The reward prediction model 374 may generate reward values 370 for each potential candidate action 372 sequentially (e.g., receiving each combination of the personalized user representation sₜ 366 and candidate action 372 serially) and/or in parallel (e.g., receiving one or more combinations of the personalized user representation sₜ 366 and individual candidate actions 372 and generating two or more output reward values 370 simultaneously). In some embodiments, multiple instances of the reward prediction module 374 may be implemented and/or the reward prediction module 374 may include multiple instances of an underlying prediction mechanism, such as a reward prediction model (discussed in greater detail below).

A Reward value 370 may be generated in real-time (e.g., during a user session) and/or offline (e.g., prior to the start of a user session based on a prior user state and/or prior user interactions). In some embodiments, initial reward values may be generated based on user historical interactions and/or a prior user state. The initial reward values may be updated and/or replaced in real-time based current, in-session interactions and/or user state(s). The historical user interactions and/or prior user state(s) may be determined based on session data for a most recent user session, a predetermined number of user sessions, and/or a set of user interactions over a predetermined time period (e.g., last 90 days, last 60 days, last 45 days, etc.).

In some embodiments, the reward prediction module 374 includes a trained reward prediction model configured to receive the personalized user representation sₜ 366 and a candidate action 372 and generate a corresponding reward value 370. The trained reward prediction model may include any suitable trained model, such as, for example, a multi-objective reward model configured to optimize a multi-objective reward loss function. The multi-objective reward loss function may be expressed as:

$${min}_{θ} {\sum }_{i = 1}^{n} {\sum }_{j = 1}^{m} {LTV}_{{a}^{j}} * L [ {r}_{θ} ( {c}_{i} , {a}_{i}^{j} ) , {r}_{〈 {c}_{i} , {a}_{i}^{j} 〉} ]$$

where LTVₐ_{^{j}} is a lifetime value factor (LTV) of an action a^{j}, L is a loss function expressing a difference between an actual action taken and a predicted action, m is the total number of potential actions, n is the total number of users, and cᵢ is a current user state. The current user state, cᵢ, may include a triplet cᵢ: [symbol] dₜ, aₜ₋₁, oₜ [symbol] . In some embodiments, L is a mean squared error loss function (e.g., R×R→R) such that:

$$Loss = {\sum }_{i = 1}^{n} {( {r}_{i}^{actual} - {r}_{i}^{pred} )}^{2}$$

where r^{actual}=r·y_{actual} and r^{pred}=r·pᵢ, and where r is a response reward matrix, y_{actual} is an actual response matrix, and pᵢ is a predicted response matrix.

In some embodiments, LTVₐ_{^{j}} may be generated based on historical information corresponding to a lift in one or more metrics generated by a user interacting with the presented action and/or a presented action reminder (e.g., a nudge). For example, in some embodiments, LTVₐ_{^{j}} may be equal to an average change in one or more metrics over a predetermined period of time and/or may be scaled by a predetermined factor. LTVₐ_{^{j}} is configured to quantify a long term value increase of an action conversion (e.g., action execution) as compared to users in a similar segment that did not execute the action. Incorporation of LTVₐ_{^{j}} into a reward loss function provides optimization for long-term value generation of individual actions.

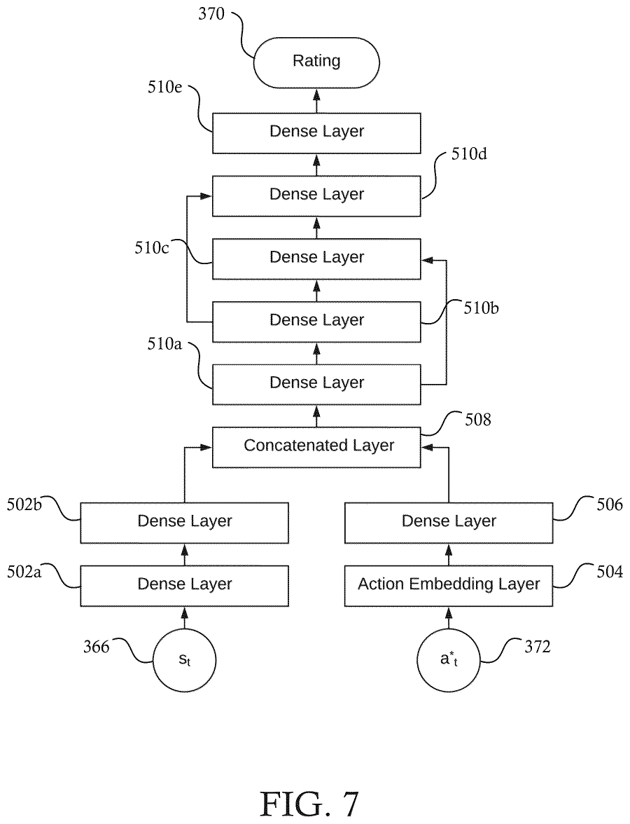

In some embodiments, a response-reward prediction model may be configured to generate response-reward values for use in the loss function L. The response-reward prediction model may include any suitable model, such as, for example, a Residual Network framework. FIG. 7 illustrates a ResNet framework 500 configured to measure a reward of each decision action on a user, in accordance with some embodiments. As illustrated in FIG. 7, the ResNet framework 500 can include a first set of dense layers 502a, 502b configured to receive the personalized state representation (se) 366 as an input and an action embedding layer 504 and a second dense layer 506 configured to receive a candidate action 372. The action embedding layer 504 may be configured to generate an embedding representation of the corresponding candidate action 372 for use by the ResNet framework 500. In some embodiments, the action embedding layer 504 may be omitted and the candidate action 372 may be provided as a pre-generated action embedding representation.

An output of the first set of dense layers 502a, 502b and the second dense layer 506 may be provided to a concatenation layer 508 configured to generate a concatenated output including the personalized state representation (se) 366 and the candidate action 372 (e.g., an embedding representation of the candidate action 372). The output of the concatenation layer 508 is provided to a stack of interconnected dense layers 510a-510e. The outputs of each of the dense layers 510a-510e may be provided to one or more additional dense layers 510a-510e. An output of a final dense layer 510e may be provided as an action reward value 370.

As one non-limiting example, a set of potential actions may include three actions, e.g., a first action, a second action, and a third action. A response-reward prediction model may generate a set of reward values for each of the actions such as a reward value of 2× for the first action, a reward value of 1× for the second action, and a reward value of −1× for the third action. A loss value (e.g., rᵢ^{actual}−rᵢ^{pred}) for an action response for each of the three potential actions may include a response matrix r: [2 1 −1], an actual response matrix yᵢ: [0 1 0], and a predicted response matrix pᵢ: [0.1 0.2 0.7], yielding a predicted reward of rᵢ^{pred}=−0.3, e.g.:

$${r}_{i}^{pred} = r \cdot {p}_{i} = 2 * 0.1 + 1 * 0.2 + - 1 * . 07 = - 0.3$$

and an actual reward value of rᵢ^{actual}=1, e.g.:

$${r}_{i}^{actual} = r \cdot {y}_{i} = 2 * 0 + 1 * 1 + - 1 * 0 = 1$$

yielding a loss value of 1.69, e.g., (1−(−0.3))²=1.3²=1.69.

With reference again to FIGS. 3-4, at step 310, each candidate action 372 is ranked 378 by reward value 370 and a set of highest ranked candidate actions 376 is selected for inclusion and/or presentation in an interface (e.g., a set of the N highest ranked candidate actions is selected, where N is an integer greater than or equal to one). The candidate actions 372 may be ranked by any suitable ranking process and/or algorithm, such as a comparison process, a sorting algorithm, a ranking model, etc.

At step 312, an interface 380 is generated. The interface 380 includes one or more interface elements including and/or representative of the set of highest ranked candidate actions 376. For example, in some embodiments, the interface 380 includes one or more programmatically-generated interface elements configured to provide a navigational shortcut to an interface page configured to allow execution of one or more of the candidate actions in the set of highest ranked candidate actions 376. As another example, in some embodiments, the interface 380 includes one or more interface elements that are configured to execute and/or complete at least one of the actions in the set of highest ranked actions 376. It will be appreciated that the interface may include any set of suitable interface elements representative of and/or configured to allow execution of one or more of the set of highest ranked candidate actions 376.

At step 314, feedback data 390 including additional user session data and/or historical data including one or more executed actions and one or more responses may be received. The feedback data 390 may be received directly in response to generation and presentation of the interface 380 and/or may be generated as part of operation of a network interface, e.g., as part of a log file or other activity aggregation process. At step 316, the feedback data 390 may be used to update one or more trained models, such as a trained personalized representation model and/or a response-reward prediction model. The feedback data 390 may be included in and/or used to generate training data to refine and/or retrain one or more of the disclosed models.

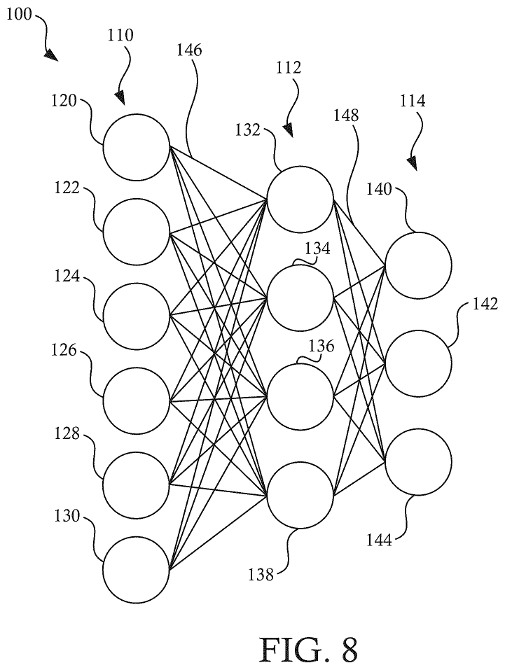

FIG. 8 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 8 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here, xᵢ(n) denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾ if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f^{c} is the first derivative of the activation function, and γⱼ⁽ⁿ⁺¹⁾ is the comparison training value for the j-th node of the output layer 114.

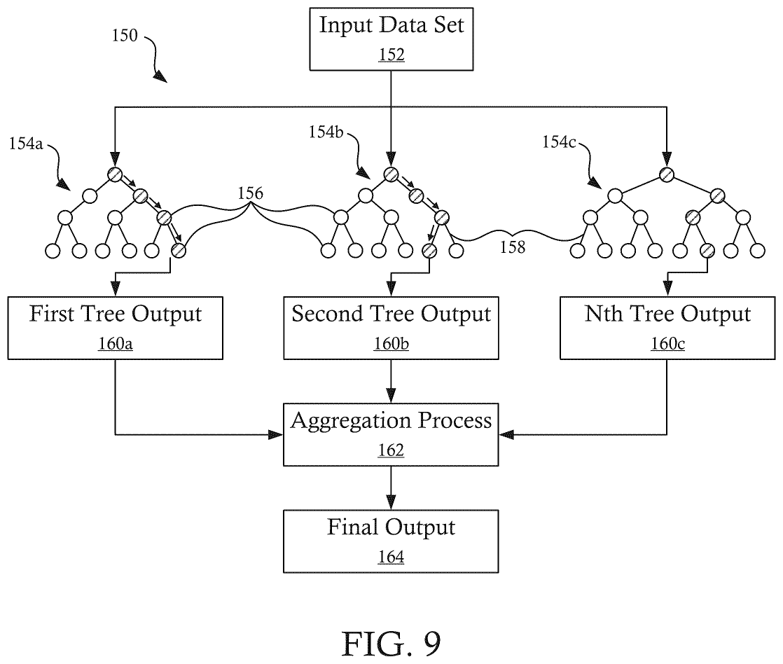

FIG. 9 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c may include a classification and/or a regression tree (CART). Classification trees include a tree model in which a target variable may take a discrete set of values, e.g., may be classified as one of a set of values. In classification trees, each leaf 156 represents class labels and each of the branches 158 represents conjunctions of features that connect the class labels. Regression trees include a tree model in which the target variable may take continuous values (e.g., a real number value).

In operation, an input data set 152 including one or more features or attributes is received. A subset of the input data set 152 is provided to each of the trained decision trees 154a-154c. The subset may include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 may apply a majority-voting process to identify a classification selected by the majority of the trained decision trees 154a-154c. As another example, in embodiments including regression trees, the tree-based neural network 150 may apply an average, mean, and/or other mathematical process to generate a composite output of the trained decision trees. The final output 164 is provided as an output of the tree-based neural network 150.

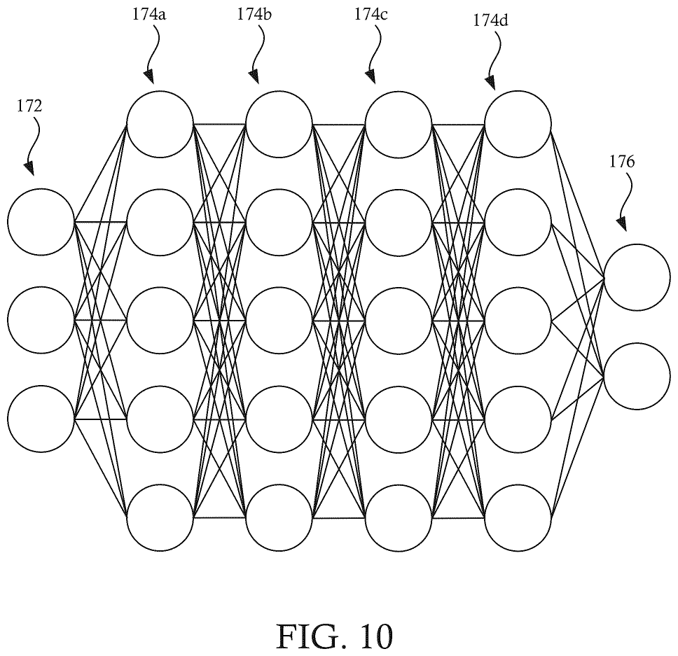

FIG. 10 illustrates a deep neural network (DNN) 170, in accordance with some embodiments. The DNN 170 is an artificial neural network, such as the neural network 100 illustrated in conjunction with FIG. 8, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x.

Identification of next-action interface elements associated with a next-best action can be burdensome and time consuming for users, especially if such actions are not displayed on a current interface page and/or are not provided after execution of other related actions. Typically, a user may locate information regarding desired actions or assets by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page of interest. Thus, the user frequently has to perform numerous navigational steps to arrive at a page containing information regarding advantageous next actions.

Systems including trained personalized representation models and/or trained reward prediction models, as disclosed herein, significantly reduce this problem, allowing users to locate next-best actions with fewer, or in some case no, active steps. For example, in some embodiments described herein, when a user is presented with an interface including one or more next-best actions, each interface element includes, or is in the form of, a link to an interface page for execution of the identified next-best action. Each recommendation thus serves as a programmatically selected navigational shortcut to an interface page, allowing a user to bypass the navigational structure of the browse tree. Beneficially, programmatically identifying next-best actions and presenting a user with navigations shortcuts to these tasks may improve the speed of the user's navigation through an electronic interface, rather than requiring the user to page through multiple other pages in order to locate the desired action via the browse tree or via a search function. This may be particularly beneficial for computing devices with small screens, where fewer interface elements are displayed to a user at a time and thus navigation of larger volumes of data is more difficult.

It will be appreciated that generation of a personalized user representation and/or calculation of a next-action reward as disclosed herein, particularly on large datasets intended to be used network interface such as e-commerce interfaces, is only possible with the aid of computer-assisted machine-learning algorithms and techniques, such as using trained personalized representation models and/or trained reward prediction models, as disclosed herein. In some embodiments, machine learning processes including reinforced coupled recurrent networks, residual networks, and/or other disclosed networks are used to perform operations that cannot practically be performed by a human, either mentally or with assistance, such as identification of a next-best action based on historical actions and responses. It will be appreciated that a variety of machine learning techniques can be used alone or in combination to generate reinforced coupled recurrent networks, residual networks, and/or other disclosed networks and/or outputs of the corresponding models.

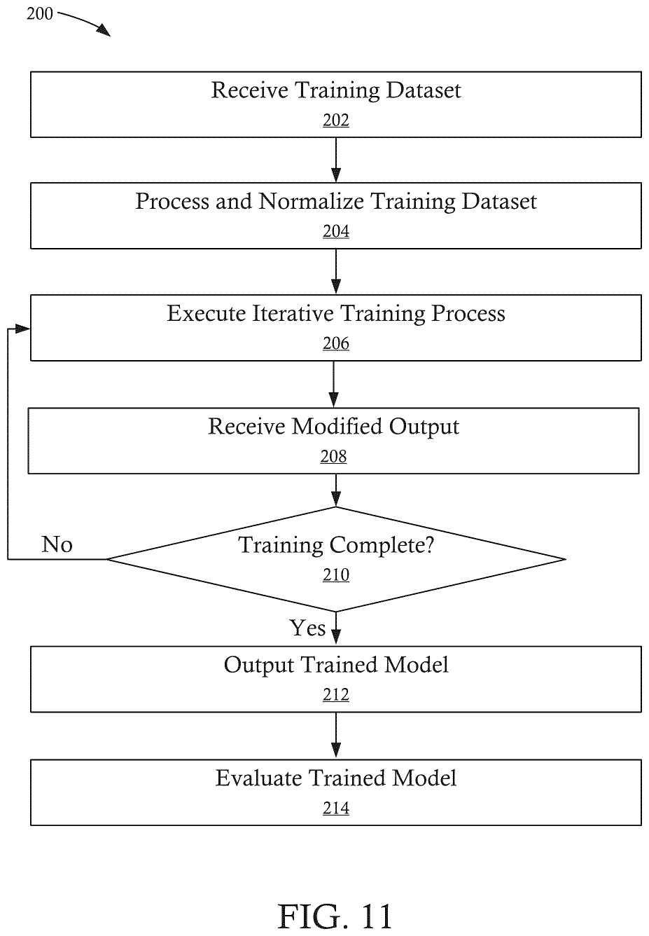

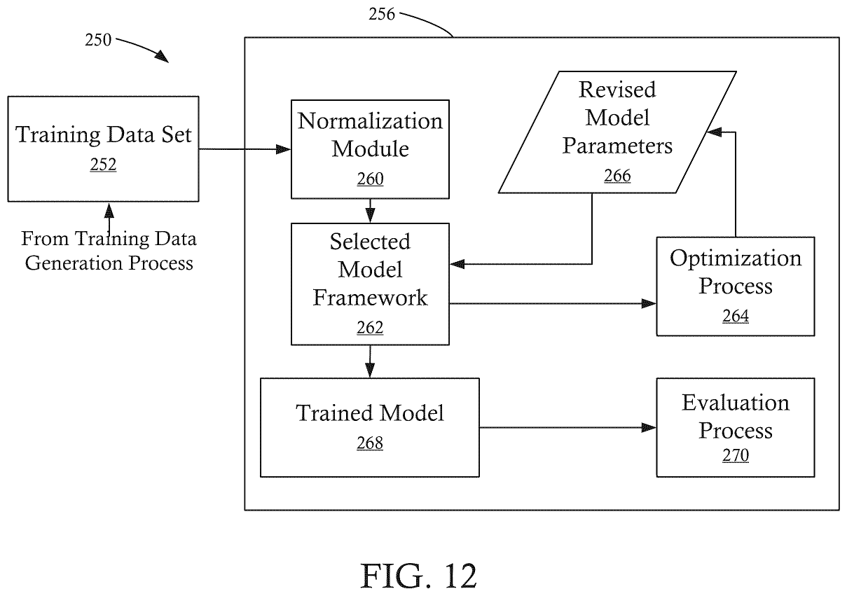

In some embodiments, a personalized representation module and/or a reward prediction module can include and/or implement one or more trained models, such as a trained personalized representation model or a trained reward prediction model, respectively. In some embodiments, one or more trained models can be generated using an iterative training process based on a training dataset. FIG. 11 illustrates a method 200 for generating a trained model, such as a trained optimization model, in accordance with some embodiments. FIG. 12 is a process flow 250 illustrating various steps of the method 200 of generating a trained model, in accordance with some embodiments. At step 202, a training dataset 252 is received by a system, such as a processing device 10. The training dataset 252 can include labeled and/or unlabeled data.

At optional step 204, the received training dataset 252 is processed and/or normalized by a normalization module 260. For example, in some embodiments, the training dataset 252 can be augmented by imputing or estimating missing values of one or more features associated with user features and/or reward prediction. In some embodiments, processing of the received training dataset 252 includes outlier detection configured to remove data likely to skew training of a trained personalized representation model or a trained reward prediction model. In some embodiments, processing of the received training dataset 252 includes removing features that have limited value with respect to training of a trained personalized representation model or a trained reward prediction model.

At step 206, an iterative training process is executed to train a selected model framework 262. The selected model framework 262 can include an untrained (e.g., base) machine learning model, such as a reinforced coupled recurrent network framework, a residual network framework, etc., and/or a partially or previously trained model (e.g., a prior version of a trained model). The training process is configured to iteratively adjust parameters (e.g., hyperparameters) of the selected model framework 262 to minimize a cost value (e.g., an output of a cost function) for the selected model framework 262. For example, with respect to a trained reward prediction model, the cost value may be related to a loss between a predicted function and an actual function in the training dataset.

The training process is an iterative process that generates set of revised model parameters 266 during each iteration. The set of revised model parameters 266 can be generated by applying an optimization process 264 to the cost function of the selected model framework 262. The optimization process 264 can be configured to reduce the cost value (e.g., reduce the output of the cost function) at each step by adjusting one or more parameters during each iteration of the training process.

After each iteration of the training process, at step 208, a determination is made whether the training process is complete. The determination at step 208 can be based on any suitable parameters. For example, in some embodiments, a training process can complete after a predetermined number of iterations. As another example, in some embodiments, a training process can complete when it is determined that the cost function of the selected model framework 262 has reached a minimum, such as a local minimum and/or a global minimum.

At step 210, a trained model 268, such as a trained personalized representation model or a trained reward prediction model, is output and provided for use in one or more operations, such as the next-action prediction and interface generation method 300 discussed above with respect to FIGS. 3-4. At optional step 212, a trained model 268 can be evaluated by an evaluation process 270. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
receive a request for an interface including a set of features representative of a user associated with the request;
generate a user state representation including an implicit user state representation and an explicit user state representation based on the set of features and session data for at least one session associated with the user;
generate an action reward value for each of a plurality of candidate actions based on the user state representation; and
generate an interface including at least one interface element representative of a candidate action having a highest action reward value.

2. The system of claim 1, wherein the user state representation is generated by a trained personalized representation model including a first portion configured to generate the implicit user state representation and a second portion configured to generate the explicit user state representation.

3. The system of claim 2, wherein the first portion of the trained personalized representation model comprises a reinforced coupled recurrent network.

4. The system of claim 3, wherein the reinforced coupled recurrent network comprises a plurality of coupled recurrent units including a plurality of gates.

5. The system of claim 2, wherein the second portion of the trained personalized representation model comprises at least one fully-connected network.

6. The system of claim 1, wherein the action reward value for each of the plurality of candidate actions is generated based on residual network framework.

7. The system of claim 6, wherein the action reward value for each of the plurality of candidate actions is generated based on a difference between an actual action taken by a user and a predicted action based on the residual network framework.

8. The system of claim 1, wherein the action reward value for each of the plurality of candidate actions includes a lifetime value factor and a loss value.

9. The system of claim 1, wherein user state representation is generated based on a user representation including a triplet comprising historical user features, a current action, and a current response.

10. A computer-implemented method, comprising:
receiving a request for an interface including a set of features representative of a user associated with the request;
generating a user state representation including an implicit user state representation and an explicit user state representation based on the set of features and a user representation including a triplet comprising historical user features, a current action, and a current response;
generating an action reward value for each of a plurality of candidate actions based on the user state representation; and
generating an interface including at least one interface element representative of a candidate action having a highest action reward value.

11. The computer-implemented method of claim 10, wherein the user state representation is generated by a trained personalized representation model including a first portion configured to generate the implicit user state representation and a second portion configured to generate the explicit user state representation.

12. The computer-implemented method of claim 11, wherein the first portion of the trained personalized representation model comprises a reinforced coupled recurrent network.

13. The computer-implemented method of claim 12, wherein the reinforced coupled recurrent network comprises a plurality of coupled recurrent units including a plurality of gates.

14. The computer-implemented method of claim 11, wherein the second portion of the trained personalized representation model comprises at least one fully-connected network.

15. The computer-implemented method of claim 10, wherein the action reward value for each of the plurality of candidate actions is generated based on residual network framework.

16. The computer-implemented method of claim 15, wherein the action reward value for each of the plurality of candidate actions is generated based on a difference between an actual action taken by a user and a predicted action based on the residual network framework.

17. The computer-implemented method of claim 10, wherein the action reward value for each of the plurality of candidate actions includes a lifetime value factor and a loss value.

18. A non-transitory computer readable medium having instructions stored thereon, wherein the instructions, when executed by at least one processor, cause at least one device to perform operations comprising:
receiving a request for an interface including a set of features representative of a user associated with the request;
generating a user state representation including an implicit user state representation and an explicit user state representation based on the set of features and session data for at least one session associated with the user, wherein the user state representation is generated by a trained personalized representation model including a first portion configured to generate the implicit user state representation and a second portion configured to generate the explicit user state representation, wherein the first portion of the trained personalized representation model comprises a reinforced coupled recurrent network, and wherein the second portion of the trained personalized representation model comprises at least one fully-connected network;
generating an action reward value for each of a plurality of candidate actions based on the user state representation; and
generating an interface including at least one interface element representative of a candidate action having a highest action reward value.

19. The non-transitory computer readable medium of claim 18, wherein the action reward value for each of the plurality of candidate actions is generated based on residual network framework.

20. The non-transitory computer readable medium of claim 18, wherein the action reward value for each of the plurality of candidate actions includes a lifetime value factor and a loss value.
